(19) United States
(12) Patent Application Publication
(10) Pub. No.: US 2005/0033818 A1
(43) Pub. Date: Feb. 10, 2005

(54) System and method for distributed database processing in a clustered environment

(76) Inventor: Cary Anthony Jardin, San Diego, CA (US)

Correspondence Address: Cary A. Jardin, 12662 Sabre View Cove, San Diego, CA, 92128, US

(21) Appl. No.: 10/345,811

(22) Filed: Jan. 16, 2003

(51) Int. Cl. G06F 15/167; G06F 15/16; G06F 17/30; G06F 7/00

(52) U.S. Cl. 709/213; 707/10

(57) ABSTRACT

The present invention provides a system for distributing database processing across a loosely coupled hardware platform, or a computer cluster. The system divides the data held within the database across all available resources, and then submits the database queries in parallel to all points of data storage. Once all resources have received and processed the database query, the results are sent back to a single point for final reassembly.

### FIELD OF THE INVENTION

The present invention pertains generally to computer databases, and more specifically, to increased performance accomplished by distributing database processing to a cluster, or group of individual computers connected through network or other electronic means.

### BACKGROUND OF THE INVENTION

Over the last twenty years the database server has become a central and critical element of business infrastructure. Businesses rely on the database to be the safe harbor for the storage and retrieval of vital information. This requirement on reliability has produced a substantial problem for the field of computer science; technology can either be reliable, or it can be fast but rarely both. The traditional, and accepted response to the problem has been ever larger database servers to handle the performance requirements while not jeopardizing reliability. Unfortunately, the larger computer servers get, the more expensive they become. The novelty of the present invention provides the ability to effectively distribute database load amongst a group, or cluster of computers to improve database performance and decrease the cost of database infrastructure. Prior technology surrounding the database field is a constant game of give and take; performance can be had at the expense of reliablity. However, before the novelty of the present invention is explored deeper, it is first warranted to describe the fundamental building blocks and prior technologies.

The field of database technology is as old as computers themselves. Computers can execute basic arithmetic and Boolean logic very quickly, but rely on input to do something useful. For example, instructing a computer to add one plus one produces the result of two. The speed at which the result is generated is dependant upon the speed of the electrical device doing the calculation, and the speed at which the instruction and data is received and stored. If a user manually enters the command, the time it takes to produce a result is a function of how fast the user can type and how fast the result can be read. Very quickly the speed of the electrical devices doing these calculations outpaced even the fastest typist; thus the field of database was begun. In its simplest form, a database is a repository for the storage, and retrieval of information. In the beginning these systems simply provided batch input for programs, and stored the output. Over the years the use of computing technologies expanded from missile trajectory programs, to accounting, to games. Likewise, the database has evolved from an internal function which supports the execution of programs, to a stand-alone system.

Today's database still provides the same, crucial role of storing and retrieving data, but now it is a stand-alone application. Client applications connect to the database via network, or by other programmatic means, to store and retrieve data. The form of these requests most commonly takes the form of Structured Query Language (SQL). Based on the mathematical discipline of set theory, client applications can now define a set of information, and an action to apply to the set. For example, the following SQL returns the title of all patents invented by Cary Jardin:
SELECT TITLE FROM PATENT_TABLE WHERE INVENTOR=‘Cary Jardin’;

With SQL applications, users can store and retrieve information from a database in a precise, logical, and standard way. Unfortunately, like the typist inputting too slow, applications that rely on a database for storage and retrieval of information are only as fast as the database that can provide the information. This is known as a bottleneck; a system or unit that hinders the performance of the entire solution. Bottlenecks never go away, they just move. First, it was the typist not being able to enter commands fast enough. For the purpose of this invention the database is the bottleneck.

### SUMMARY OF THE INVENTION

The present invention disclosed and claimed herein, in one aspect thereof, comprises a method of increasing database performance by distributing database load across a group, or cluster of computers.

### DESCRIPTION OF THE FIGURES

FIG. 1 illustrates a block diagram of the subject system for database request handling to accomplish the load distribution of a database request to a cluster of computers; and

FIG. 2 illustrates an overall system architecture in which the master database system is disposed in a network in front of the clustered database resources and a client to accomplish the database load distribution.

### DETAILED DESCRIPTION OF THE INVENTION

Distributing database processing across multiple computer resources is a very difficult and novel task. It starts by configuring a cluster of computers. For the purpose of the current patent, the term cluster is defined to be a group of computers with the ability to programmatically communicate with one another via electrical or optical connection. Further, a node is defined as a computer that is a member of the cluster. One such method for creating a cluster is through the use of a Ethernet (IEEE 802.3) network. In such a configuration, each node can be addressed by the Media Access Control (MAC) address, and all nodes in the cluster can be addressed through a broadcast address. With such a communication facility, each program on each node can freely communicate and transfer information with one another.

Once the cluster has been configured and all nodes have the ability to communicate with one another, each node is configured with a database server. For the purpose of example, each node will be configured with a database that understands Structured Query Language (SQL.) However, SQL is not a requirement for the present invention, it is chosen to clearly communicate the preferred embodiment of the present patent; any programmatic interface that can fulfill information storage and retrieval request can be used by the present patent.

At this point, a cluster is configured with each node running individual SQL database servers connected together through an interface to facilitate programmatic communication between the nodes. The system begins with a request being sent to one of the nodes. The SQL server on the node then determines if the request is for information retrieval (read transaction), or information storage (write transaction.) Once the database server has determined the request to be a write transaction, the database server determines which node should process the request and the unaltered request is sent to the appropriate node for fulfillment. The goal of the present invention is to distribute the database load across all nodes in the cluster. One method of load distribution is uniform distribution. In this method, each node processes 1/N of the load, where N is the number of nodes in the system. To produce this result, each node will be responsible for 1/N of the information stored in the entire system. In such a model, the database server would forward the write transaction to the sequentially next node; each node processes a write request in turn in a round robin fashion. In this way, the first write transaction would be forwarded to the first node, the second write transaction to the second node and so on until all nodes had received a write request at such point the process would begin again at the first node.

Upon a node determining a read transaction, an execution plan is formulated. Through the definition of the write transaction processing, it can be assumed that each node holds a fraction of the final answer. From the example of the uniform distribution, it can be further assumed that each node holds 1/N the total information requested. However before the formulation of the execution plan is discussed, an explanation of SQL read transactions is required:

SQL read transactions can be segmented into two distinct categories; single set read requests, and multiple set read requests. Single set read transactions can be simplified down to finding a needle in a haystack. That is, the request has defined what the needle looks like and the specific haystack to search trough. Multiple set read operations, known as a “join”, is infinitely more complicated and is the core problem facing distributed database processing. Using the needle in the hay-stack analogy, a join is a request to find a needle in a set of haystacks with each haystack overlapping to form a region of intersection. A join request defines how and where the haystacks overlap, and a description of the needle to find.

The goal of the present invention is to provide a method for distributing database load across a set of computers. Revisiting the haystack analogy, this is equivalent to each computer being responsible for searching through 1/N of each haystack. For single set read transaction this is accomplished by broadcasting the unaltered read request to all database servers in the cluster. Each server will then return a separate result that will be gathered together at the invoking database server into a single response to the original request. In this way the current invention has the informal name of, scatter, gather processing.

For join transactions the same scatter gather method is used with two additional interim steps. Upon identifying a join request, one of the sets is chosen to be the constant set. That is, in order to determine the overlapping region of all the sets, each set must be traversed to determine which elements are also present in the other sets. One method of determining the set overlap is to select one of the sets as the base set, then each element of the remaining sets are applied against the base set to determine if the element exists in both sets. Once the base has been chosen, for example the smallest set, the present invention then formulates a request to encapsulate, and transmit all sets except the base set to all nodes in the cluster. In this way, each node will process and receive N separate (1/N) pieces to form 100% (N×1/N=100%) of the non-base sets. Each 1/N sub-set of the non base sets is then applied against the 1/N base set owned by each cluster. The result being, once each node has searched for matching criteria from the 1/N base set and processed all N of the 1/N subsets sent by each node in the cluster, each node then contains 1/N of the final answer. The 1/N final answer is formulated, the result set is sent and gathered at the originating request node to be cumulated and sent as a result to the database client.

Although the preferred embodiment has been described in detail, it should be understood that various changes, substitutions and alterations can be made therein without departing from the spirit and scope of the invention as defined by the appended claims.

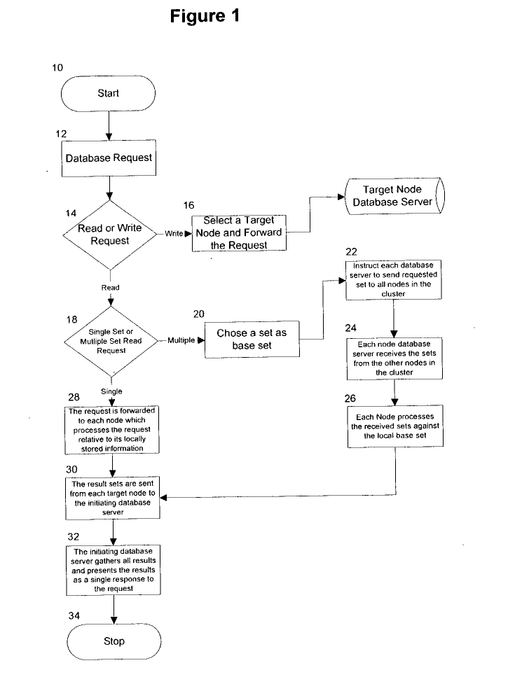

Turning to FIG. 1, an overall flow diagram of distributed database processing A accomplished in connection with the subject system is disclosed. The basic flow commences at start block 10, from which progress is made to block 12 at which point the database request is received by the, master database system. A determination is made at decision block 14 to determine whether the request is an information retrieval request, read operation, or information storage request, write operation. This determination is suitably accomplished by analysis of database requests, or other suitable criteria as dictated by the particular database application.

A write determination at decision block 14 causes progress to block 16. At this point, the database request is sent to a single node in the cluster. Determination of which node receives the request can be made in a variety of different ways with the goal being the division of the stored information across all available computer resources in the cluster. Flow progresses back to block 14 to determine whether a subsequent request meets the above test, as noted above.

A read determination at decision block 14 causes progression to block 18. At this point, a database read request is determined to contain a single or multiple sets of data. A multiple determination at decision block 18 causes progress to block 20. At a base set is chosen to be the most optimal set not to transmit to the other computers in the cluster. Once the set has been chosen, progress continues to block 22 where each computer in the cluster is instructed to send all contents of the non-base set to all the other computers in the cluster. From block 22, the information for each set is sent to the computers in the cluster and received at block 24. When the set has been received at block 24 progress continues to block 26 where each of the received sets are searched against the base set. Once all sets have been processed from the nodes in the cluster, each node possesses its own piece of the final result. The result from block 26 progressed to block 30 where the result set is sent to the initiating node. From block 30, progress proceeds to block 32 where the results are cumulated together and presented as a single response to the request.

A single determination at decision block 18 causes progression to block 28. At this point the database request is forwarded to all nodes in the cluster for processing. Once the nodes have formed a result set for the request, progress proceeds to block 30 where the results are sent to the initiating server. Upon the initiating node receiving the results from block 30 control passes to block 32 where the results are cumulated together and presented as a single response to the request.

Once completion of all relevant requests has been completed, the acceleration A is completed and the system proceeds to stop at termination block 34.

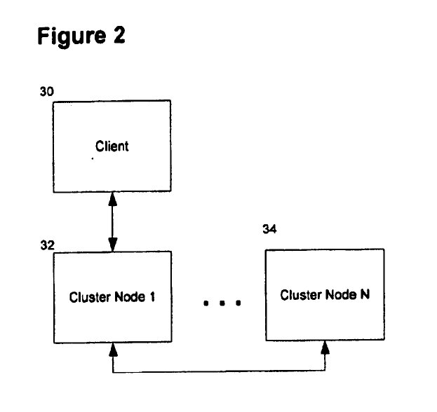

Turning next to FIG. 2, a database client environment in which a preferred embodiment database acceleration is provided. A client 30 connects to the database cluster through network, Application Programming Interface, or other means suitable for sending and receiving requests to the database server. One of the nodes in the cluster receives the request, for this diagram node one 32 receives the client requests and suitable utilizes the other nodes 34 in the cluster to fullfull the request.

1. A method for distributed database processing in a clustered computing environment comprising:
a) a computer cluster defined as a group of computers with the ability to programmatically communicate with one another via electrical or optical connection; and
b) a database server on each computer in the cluster.
